(19) United States
(12) Patent Application Publication
(10) Pub. No.: US 2017/0105389 A1
(43) Pub. Date: Apr. 20, 2017

(54) Method for Providing an Interactive Toy Response to a Received Input

(71) Applicant: Dasiris, Dana Point, CA (US)

(72) Inventor: Daniel Anthony Sanchez, Dana Point, CA (US)

(21) Appl. No.: 15/298,194

(22) Filed: Oct. 19, 2016

Related U.S. Application Data
(60) Provisional application No. 62/243,525, filed on Oct. 19, 2015.

(51) Int. Cl. A01K 15/02; A63H 33/26; A63H 5/00

(52) U.S. Cl. CPC A01K 15/025; A63H 5/00; A63H 33/26; A63H 2200/00

(57) ABSTRACT

A method for providing an interactive toy response to a received input enables an electronic toy such as a pet toy to react to interaction with the electronic toy. The electronic toy includes at least one input detection device and at least one interactive output device. A control unit is communicably coupled to the input detection device and to the interactive output device. The surrounding areas of the electronic toy are continuously monitored with the input detection device and an interactive input is received with the input detection device. The interactive input may be a bite, movement, or similar interaction with the electronic toy. The interactive input is sent to the control unit and is processed. An interactive output is executed with the interactive output device. The interactive output may be a sound, a light, a vibration, or movement of the electronic toy.

The current application claims a priority to the U.S. Provisional Patent application Ser. No. 62/243,525 filed on Oct. 19, 2015.

### FIELD OF THE INVENTION

The present invention relates generally to a method for generating a response to a toy input. More specifically, the present invention is a method for providing an interactive toy response to a received input. The present invention relates primarily to pet toys, but has applications relating to other types of toys as well.

### BACKGROUND OF THE INVENTION

Pet toys are commonly used to provide entertainment and mental stimulation to household pets. These toys are available in a wide range of sizes and shapes such as bones, squirrels, and balls. Pet toys are often used for additional purposes. Puppies are able to use chew toys to alleviate pain in their jaws and gums during teething periods. Pet toys are also useful for providing exercise and physical stimulation for pets as pets often chase thrown toys or play tug of war with their owners. As a result, the proper use of toys for mental and physical stimulation is important for the overall health of household pets.

While pet toys are often simple in design and nature, various technologies have been incorporated into pet toys to increase the functionality of the toys. For example, various pet toys vibrate, squeak, or output some other form of audio stimuli when pets interact with the toys. While these toys are useful for providing new stimuli for pets, pets quickly become bored with the toys once the novelty wears off and the pets learn how the toys function. This is primarily due to the fact that pet toys are generally simplistic in design without any real interactive functionality.

The present invention is a method for providing an interactive toy response to a received input. While the present invention primarily relates to pet toys, the present invention has applications with respect to other types of toys as well. The present invention enables the generation of an interactive toy response to an input that is received from a pet interacting with the toy.

### BRIEF DESCRIPTION OF THE DRAWINGS

FIG. 1 is a flowchart detailing the overall process that is followed by the present invention.

FIG. 2 is a flowchart detailing a secondary process that is followed by the present invention.

FIG. 3 is a flowchart detailing a secondary process that is followed by the present invention.

FIG. 4 is a flowchart detailing a secondary process that is followed by the present invention.

FIG. 5 is a flowchart detailing a secondary process that is followed by the present invention.

FIG. 6 is a flowchart detailing a secondary process that is followed by the present invention.

FIG. 7 is a flowchart detailing a secondary process that is followed by the present invention.

FIG. 8 is a flowchart detailing a secondary process that is followed by the present invention.

FIG. 9 is a flowchart detailing a secondary process that is followed by the present invention.

FIG. 10 is a flowchart detailing a secondary process that is followed by the present invention.

FIG. 11 is a flowchart detailing a secondary process that is followed by the present invention.

FIG. 12 is a flowchart detailing a secondary process that is followed by the present invention.

FIG. 13 is a flowchart detailing a secondary process that is followed by the present invention.

FIG. 14 is a flowchart detailing a secondary process that is followed by the present invention.

FIG. 15 is a flowchart detailing a secondary process that is followed by the present invention.

FIG. 16 is a flowchart detailing a secondary process that is followed by the present invention.

FIG. 17 is a flowchart detailing a secondary process that is followed by the present invention.

### DETAIL DESCRIPTIONS OF THE INVENTION

All illustrations of the drawings are for the purpose of describing selected versions of the present invention and are not intended to limit the scope of the present invention.

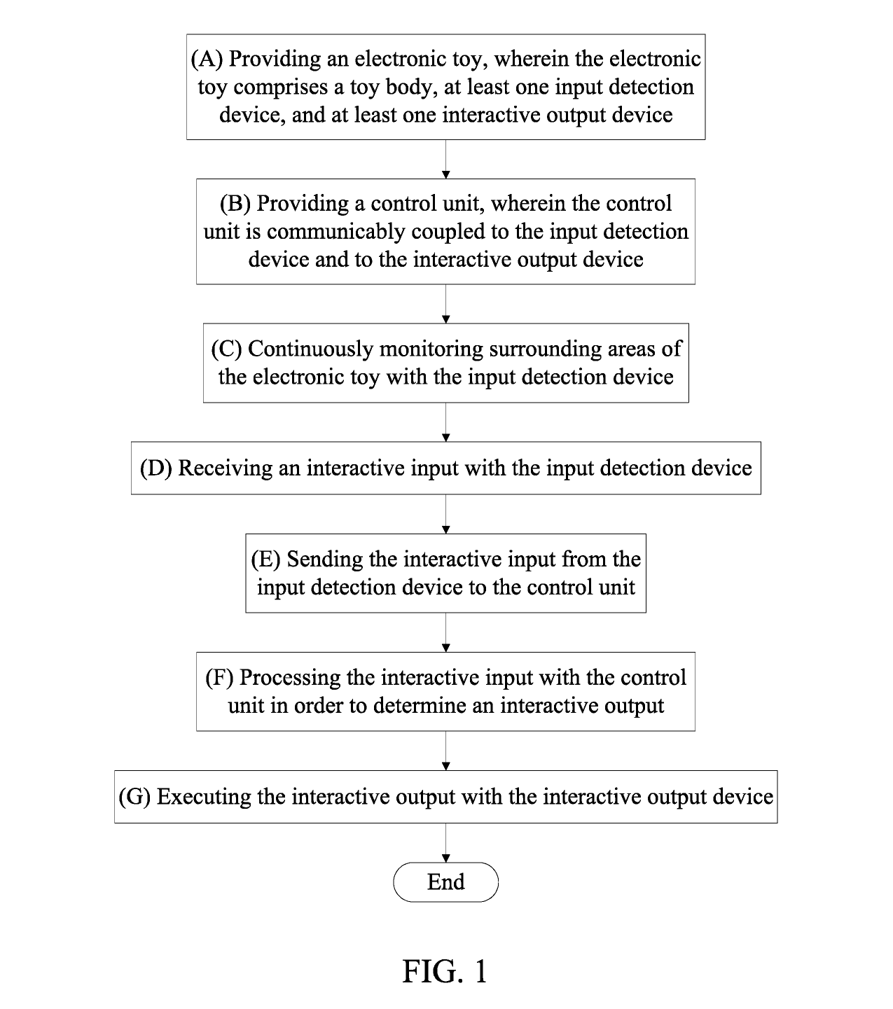

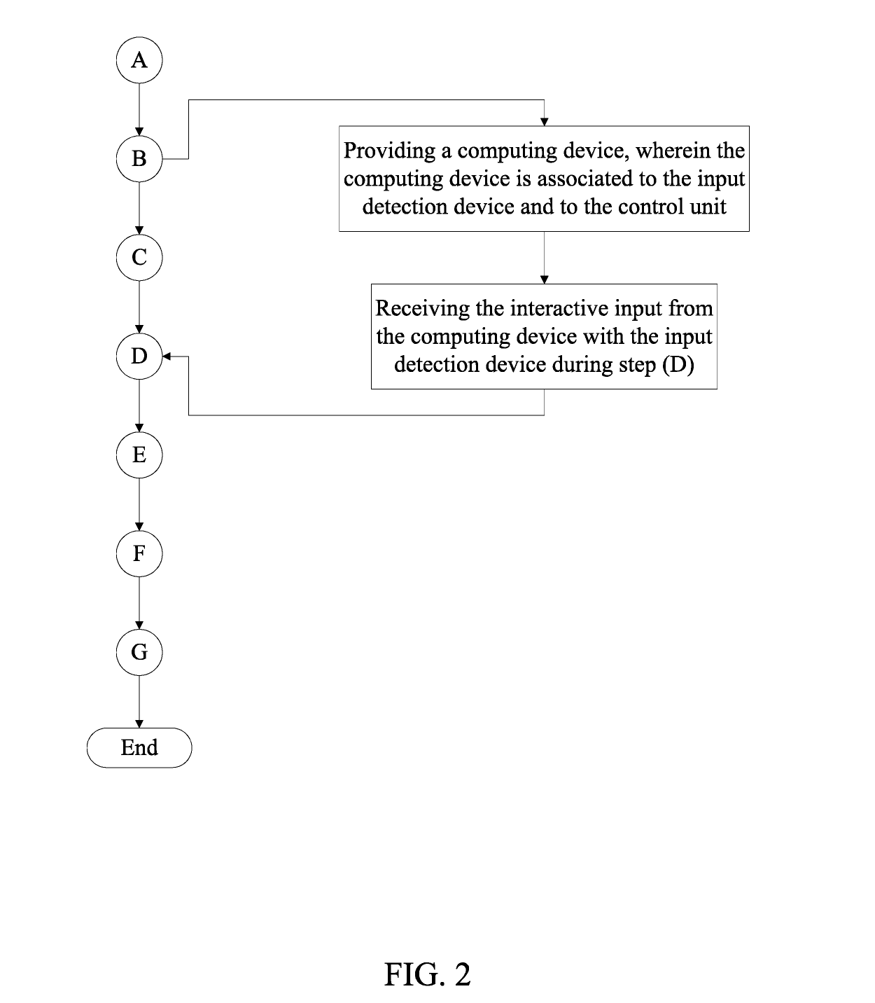

The present invention is a method for providing an interactive toy response to a received input. The overall process that is followed by the present invention is shown in FIG. 1 while secondary processes that are followed by the present invention are shown in FIGS. 2-17. The present invention primarily relates to pet toys and has applications with respect to other types of toys as well.

With reference to FIG. 1, an electronic toy such as a pet toy is provided (Step A). The electronic toy comprises a toy body, at least one input detection device, and at least one interactive output device. The present invention is not limited with respect to the specific design of the toy body. The at least one input detection device is able to receive an input from a pet interacting with the electronic toy. The interactive output device provides a response to the input from the pet. A control unit is also provided and is communicably coupled to the input detection device and to the interactive output device, enabling communications between the control unit, the input detection device, and the interactive output device (Step B).

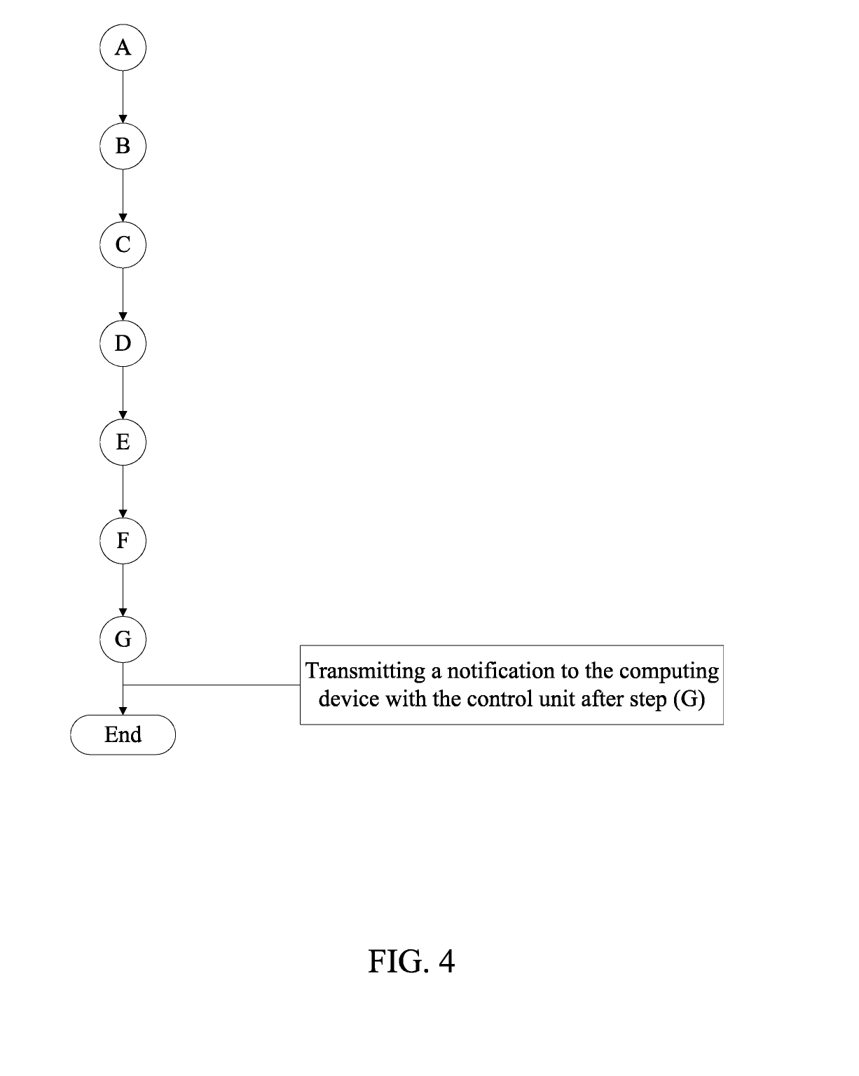

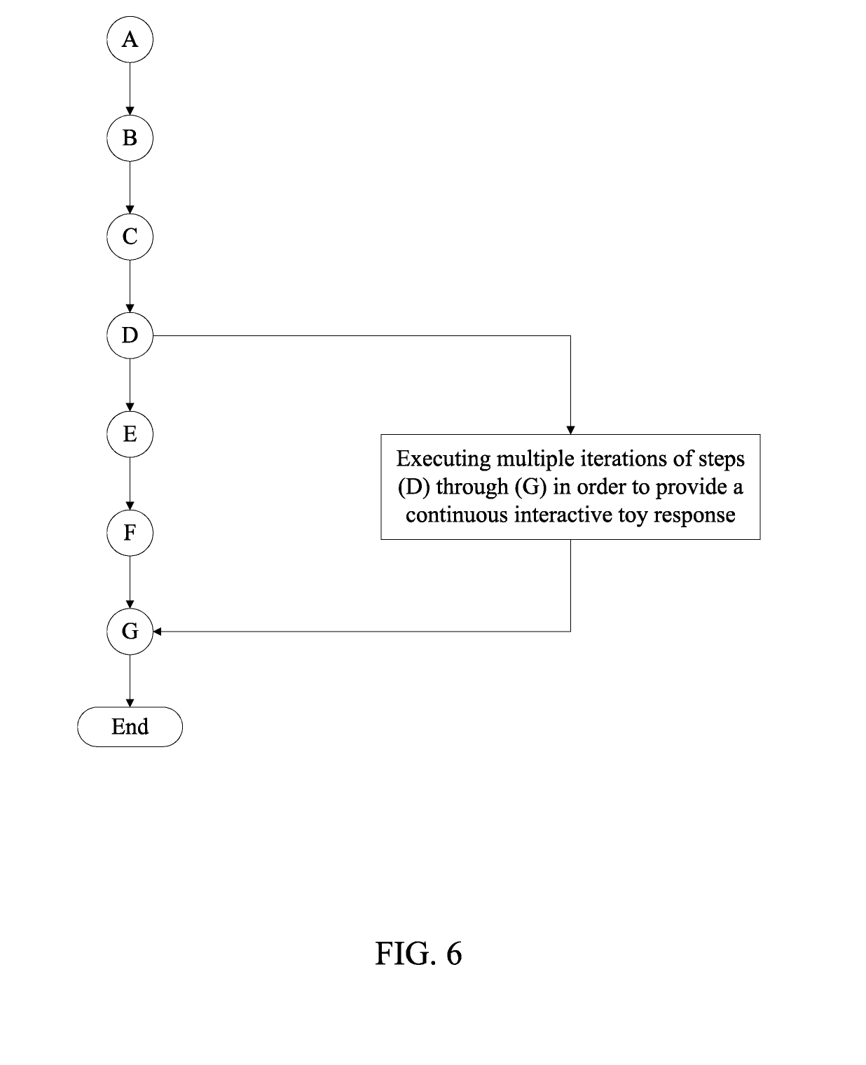

The surrounding areas of the electronic toy are continuously monitored with the input detection device, enabling a pet to interact with the electronic toy to elicit a response from the electronic toy to the interaction (Step C). An interactive input is then received with the input detection device (Step D). The interactive input may vary and includes interactions such as bites and movements. After the interactive input is received, the interactive input is sent from the input detection device to the control unit for processing (Step E). The interactive input is processed with the control unit in order to determine an interactive output (Step F). As a result, the control unit is able to recognize the interactive input to the electronic toy and implement the interactive output from the electronic toy. The interactive output is then executed with the interactive output device (Step G). Similar to the interactive input, the interactive output may vary and includes outputs such as audio, vibrations, lighting, and movement that are easily visible to a pet. With reference to FIG. 6, multiple iterations of steps (D) through (G) may be executed in order to provide a continuous interactive toy response. For example, the interactive output may be executed for the duration of time that a pet is biting into the electronic toy. As shown in FIG. 4, a notification is sent to the computing device with the control unit after step (G). The notification may be sent in the form of a push notification to the computing device and notifies a user that a pet is playing with the electronic toy.

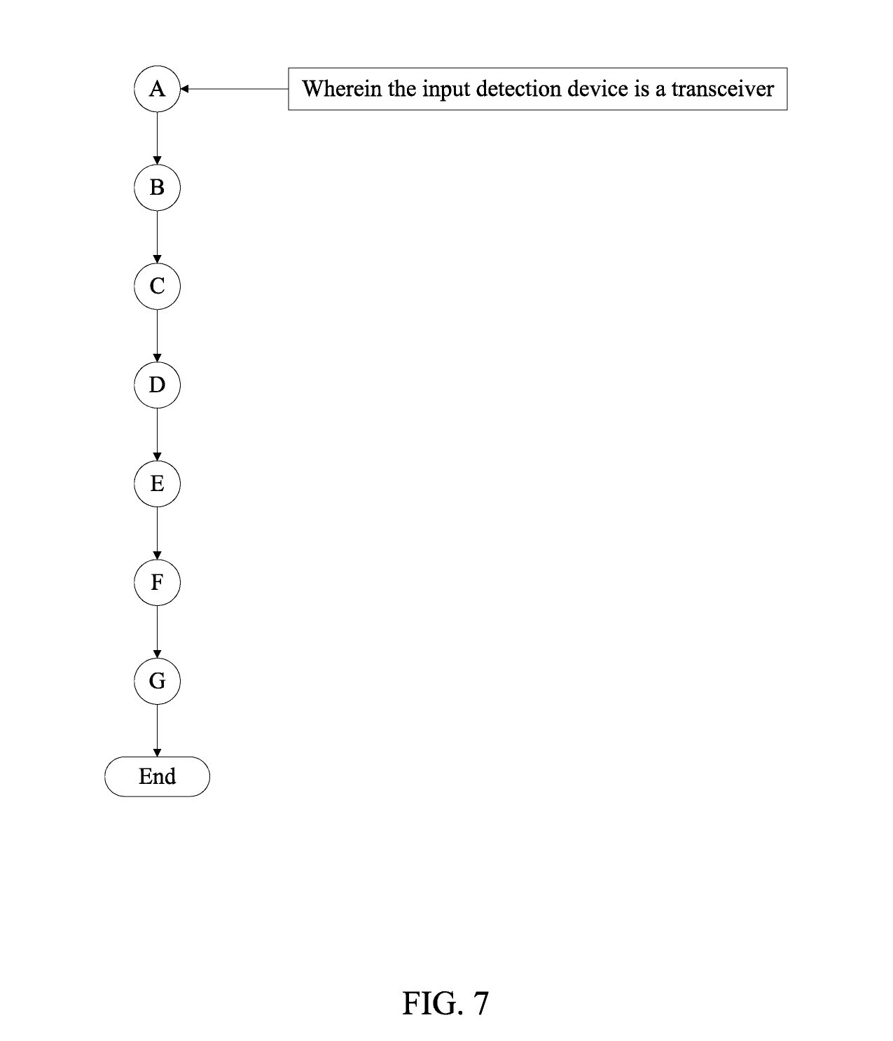

With reference to FIG. 2, a sub-process for the method of the present invention is herein discussed. A computing device is provided and is associated to the input detection device and to the control unit. The computing device may be a smartphone, a tablet computer, or a similar electronic device. The interactive input is received from the computing device with the input detection device during step (D). This allows a user to manually provide the interactive input in order to trigger the interactive output from the electronic toy. In this case, a pet does not need to directly physically interact with the electronic toy. As referenced in FIG. 7, the input detection device may be a transceiver. The transceiver enables the interactive input to be wirelessly received from the computing device.

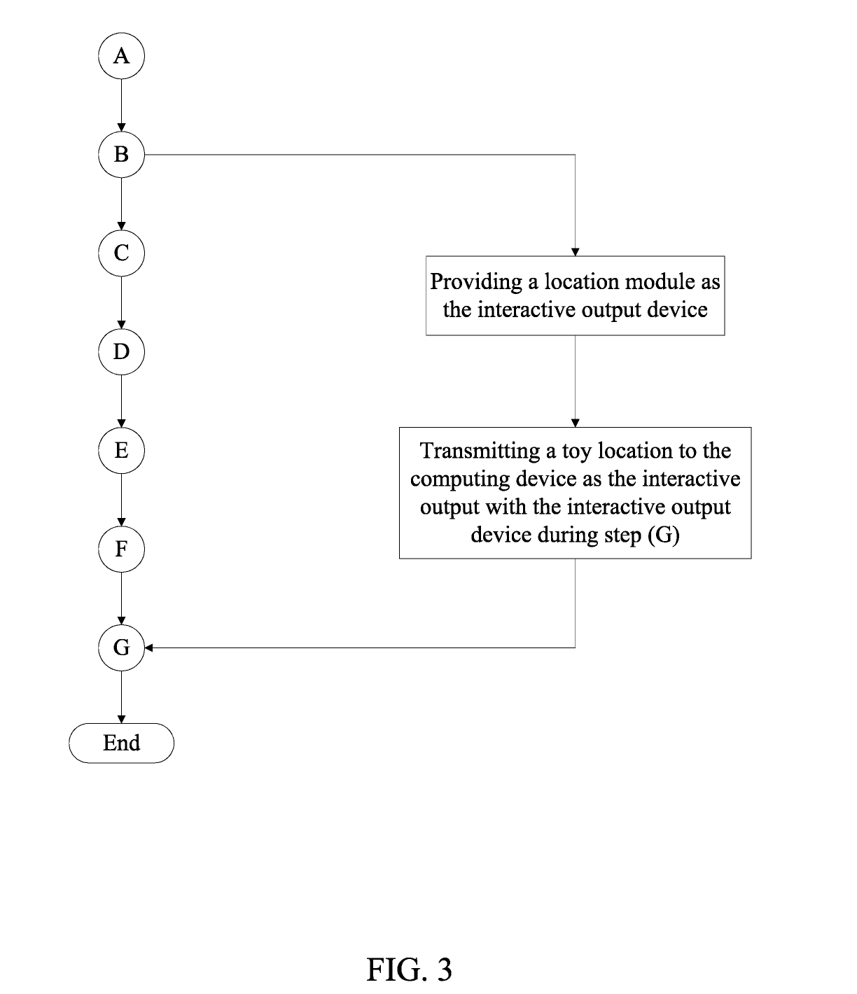

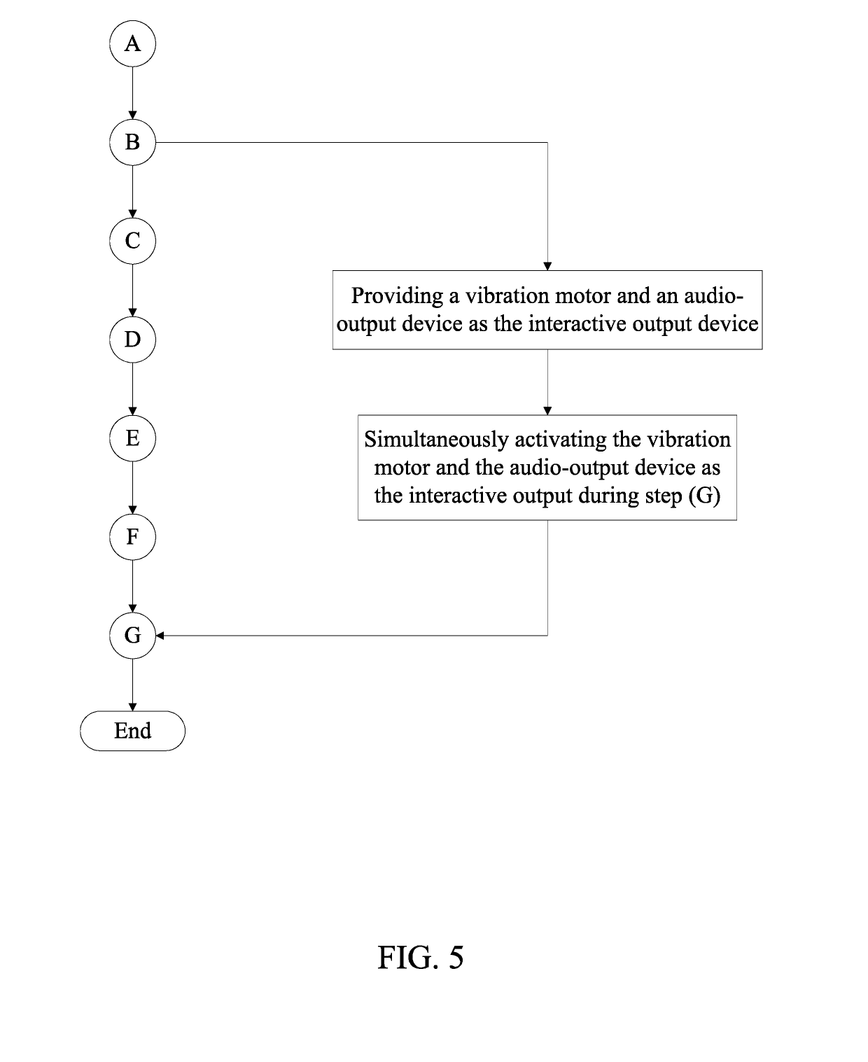

As previously discussed, the interactive output device may vary across embodiments of the present invention. With reference to FIG. 5, a vibration motor and an audio-output device are provided as the interactive output device. The vibration motor is able to vibrate the electronic toy while the audio-output device is able to emit an audible sound from the electronic toy. In this embodiment of the present invention, the vibration motor and the audio-output device are simultaneously activated as the interactive output during step (G). The vibration of the electronic toy and the audible sound emitted from the electronic toy may be used as the interactive output in order to assist the user or a pet in locating the electronic toy if the electronic toy has been lost. Similarly, with reference to FIG. 3, a location module is provided as the interactive output device. The location module is utilized to track down the electronic toy when the electronic toy has been lost. A toy location is transmitted to the computing device as the interactive output with the interactive output device during step (G).

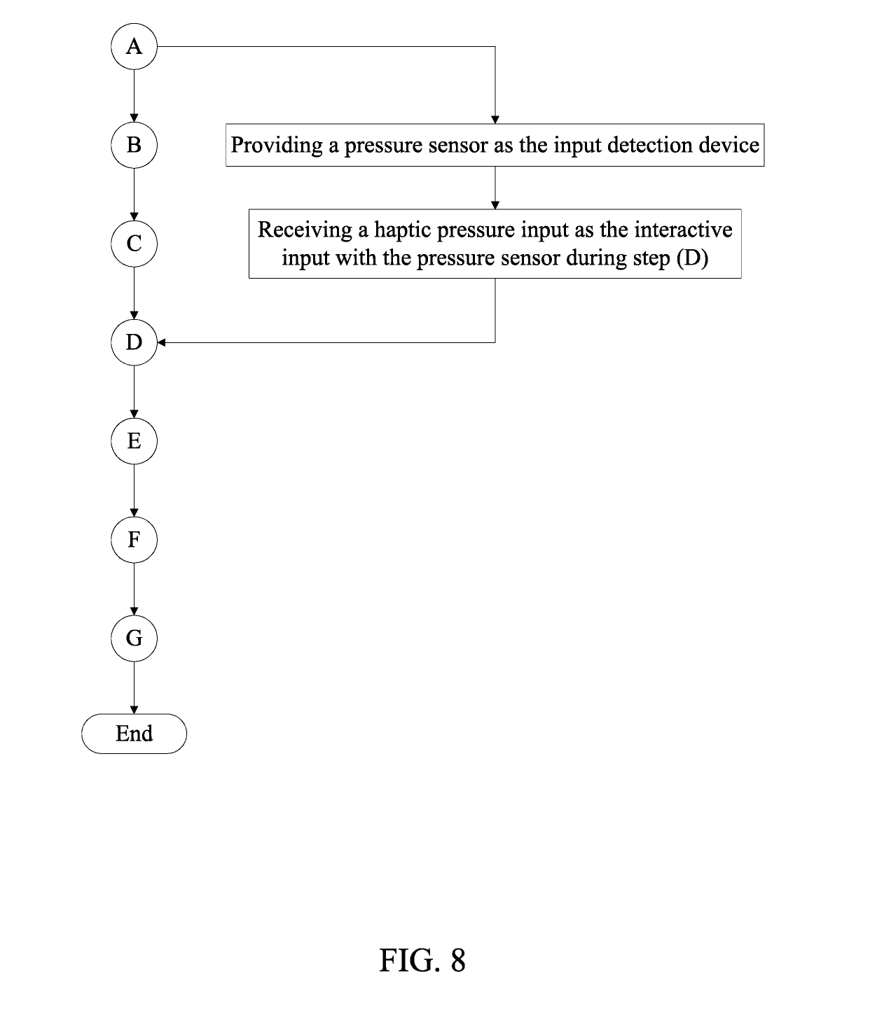

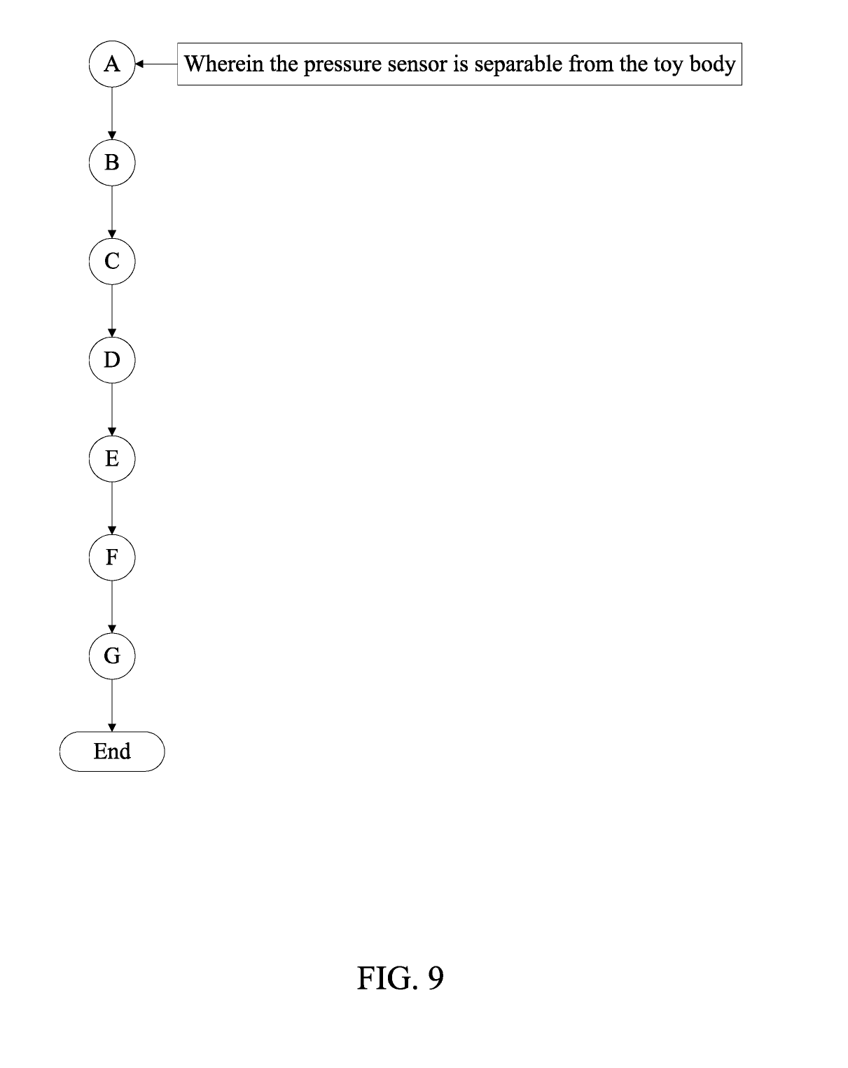

As previously discussed, the input detection device may vary across embodiments of the present invention. With reference to FIG. 8, a pressure sensor is provided as the input detection device. The pressure sensor enables a pet to bite into the electronic toy in order to elicit the interactive output from the electronic toy. A haptic pressure input (such as a bite) is received as the interactive input with the pressure sensor during step (D), allowing the interactive output to be executed. With reference to FIG. 9, the pressure sensor may be separable from the toy body. For example, the pressure sensor may be embedded into a removable and flexible shell that is attached to the toy body.

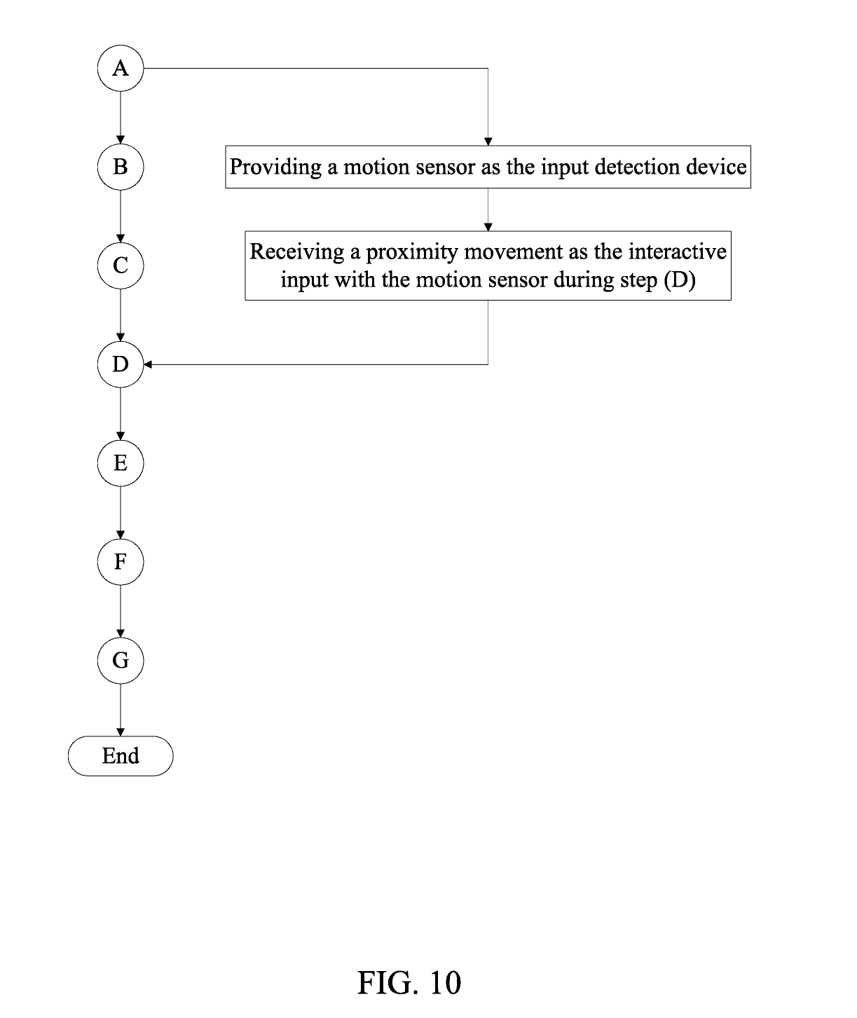

With reference to FIG. 10, a motion sensor is provided as the input detection device. The motion sensor enables a pet's movements to elicit the interactive output from the electronic toy. A proximity movement is received as the interactive input with the motion sensor during step (D), allowing the interactive output to be executed. The input detection device may also be a camera. In this case, the camera is able to detect a pet's movements in the vicinity of the electronic toy.

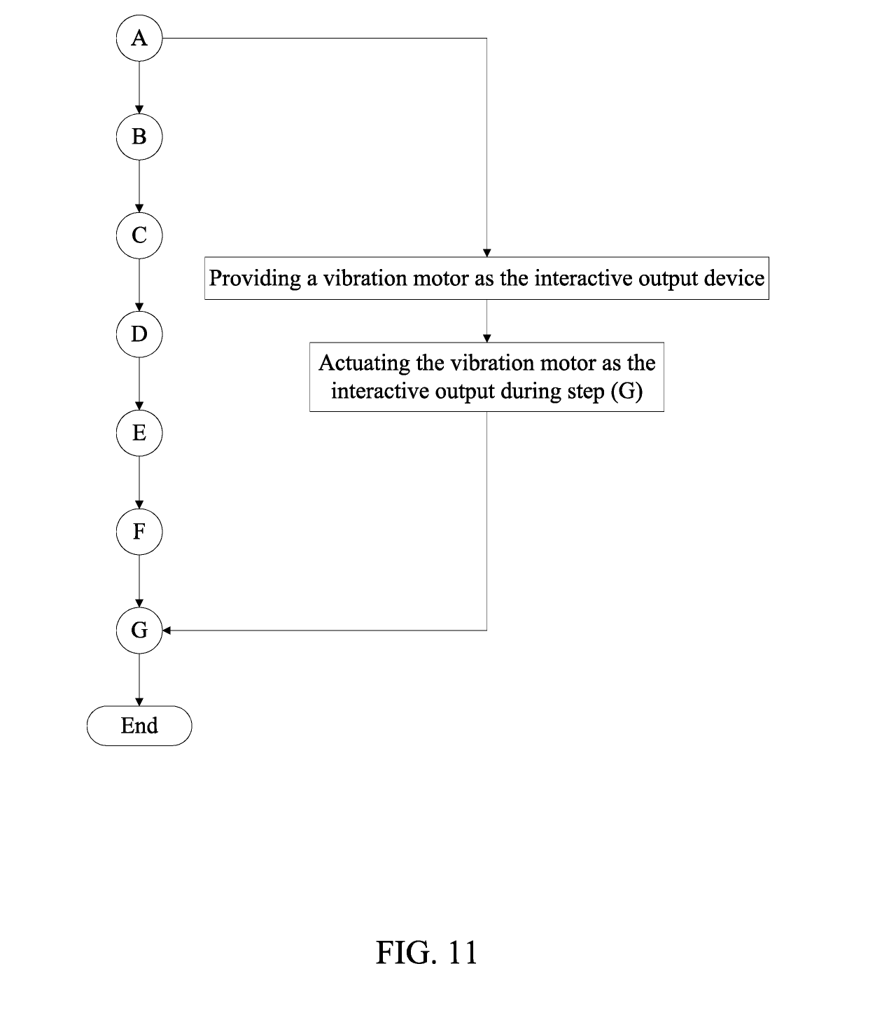

Referring to FIG. 11, a vibration motor is provided as the interactive output device. The vibration motor is able to vibrate the electronic toy in response to the interactive input. The vibration motor is actuated as the interactive output during step (G), allowing the electronic toy to vibrate.

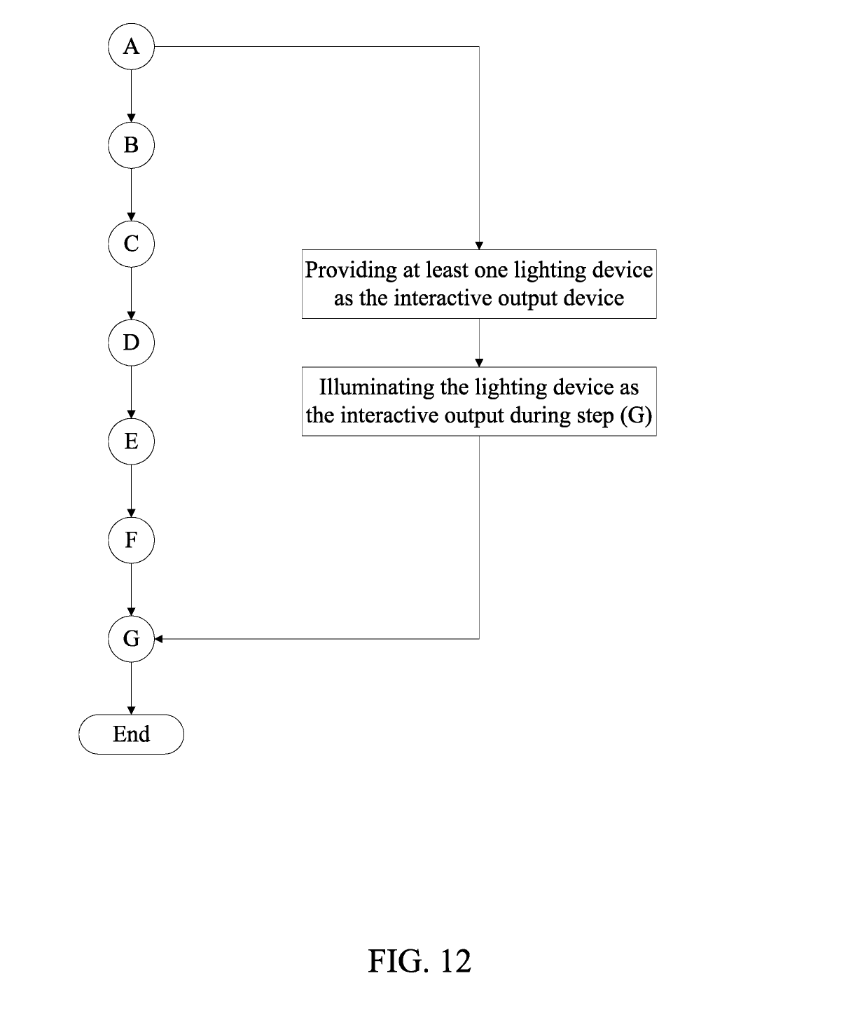

With reference to FIG. 12, at least one lighting device is provided as the interactive output device. The lighting device provides illumination to the electronic toy in response to the interactive input. The lighting device is illuminated as the interactive output during step (G), providing illumination to the electronic toy and the surrounding areas.

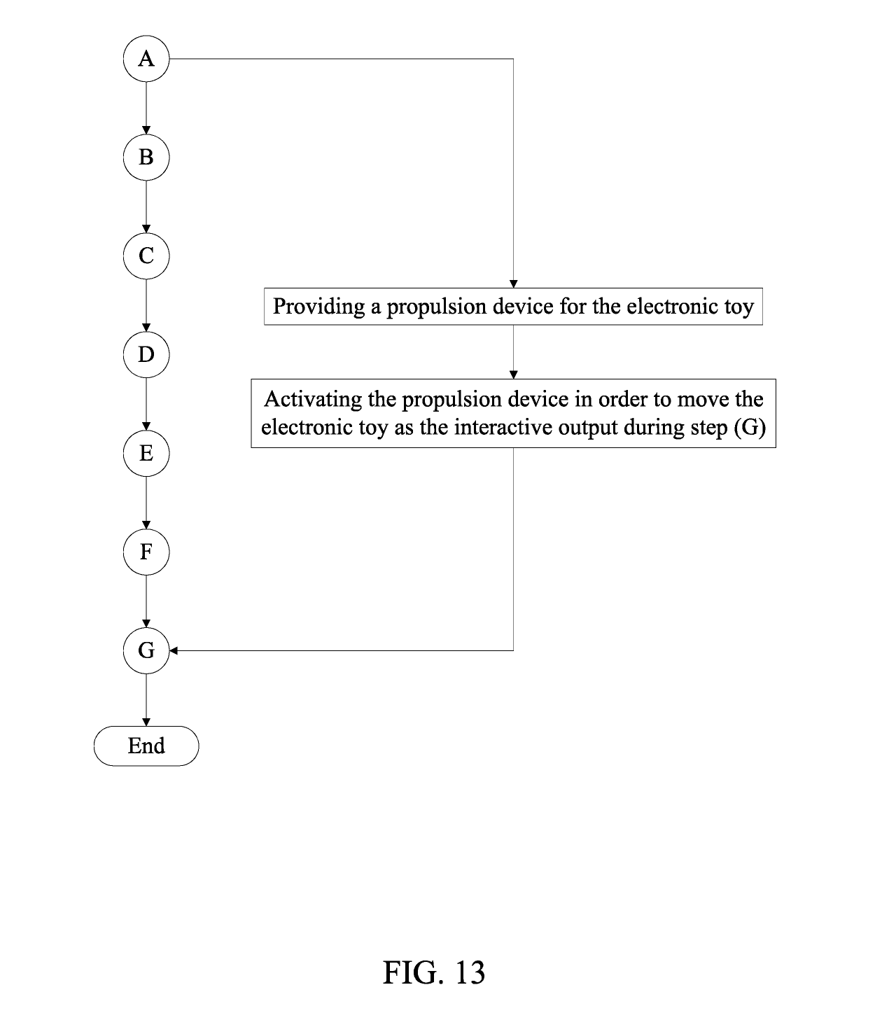

Referring to FIG. 13, a propulsion device is provided for the electronic toy. The propulsion device provides mobility for the electronic device in response to the interactive input. The propulsion device is activated in order to move the electronic toy as the interactive output during step (G). As a result, the electronic toy may move toward or away from a pet as the pet approaches the electronic toy.

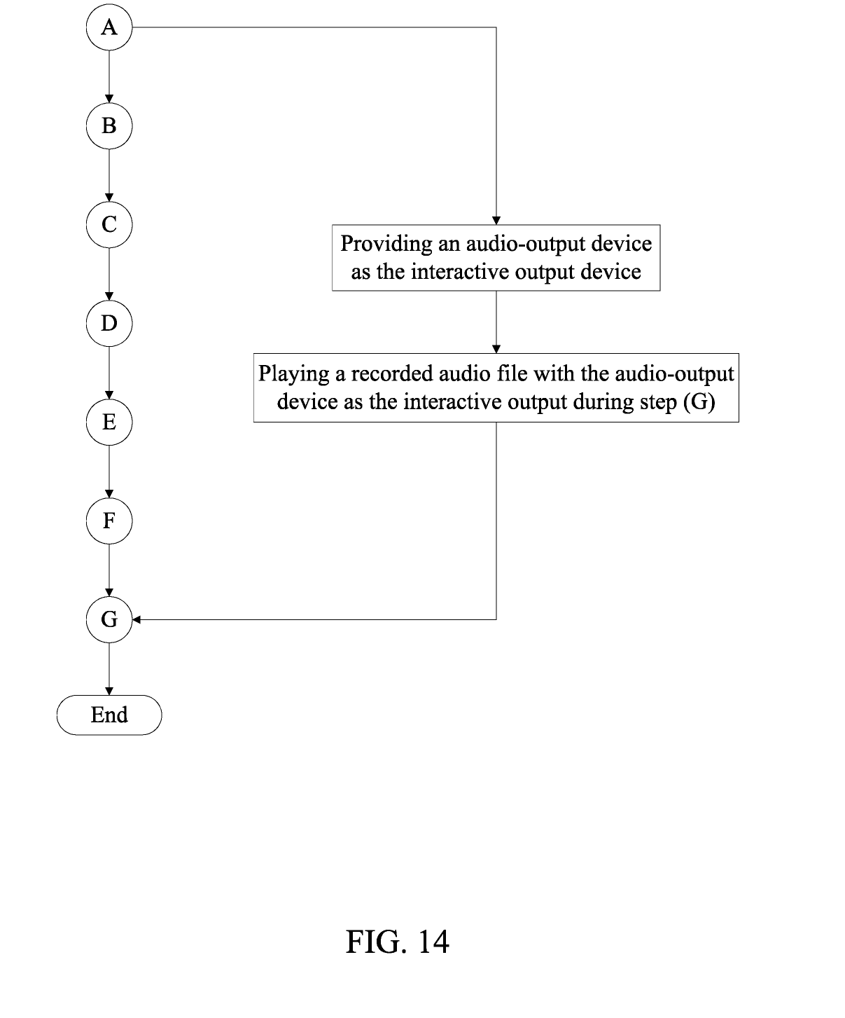

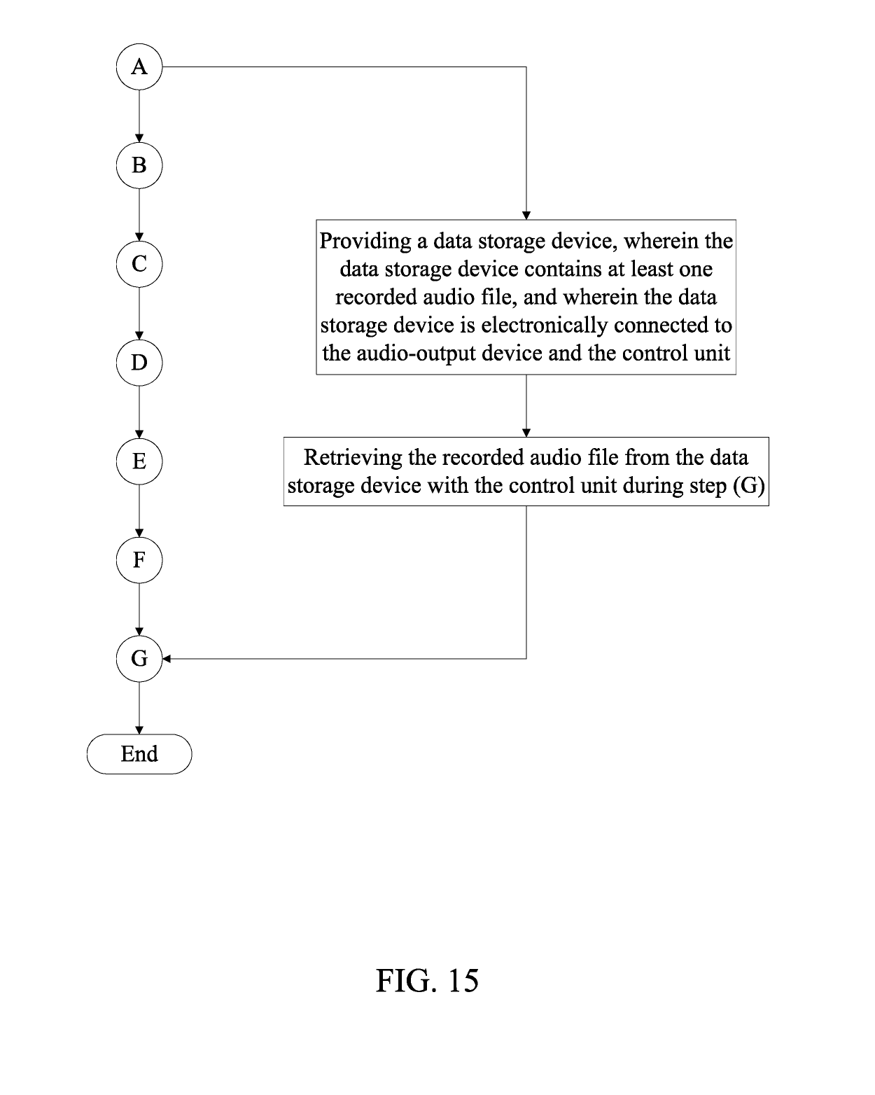

With reference to FIG. 14, an audio-output device is provided as the interactive output device. The audio-output device is able to emit an audible sound to the surrounding area in response to the interactive input. A recorded audio file is played with the audio-output device as the interactive output during step (G). The recorded audio file may be a sound clip, music, or related audio media. With reference to FIG. 15, in the preferred embodiment of the present invention, a data storage device is provided. The data storage device contains at least one recorded audio file and is electronically connected to the audio-output device and to the control unit. The control unit is thus able to select and play an audio file from the data storage device through the audio-output device. The recorded audio file is retrieved from the data storage device with the control unit during step (G). As a result, the user is able to program the control unit or manually select the recorded audio file with the control unit. The data storage device may include additional data such as configuration data for the electronic toy. The configuration data may be transferred to the data storage device by connecting the electronic toy to the computing device.

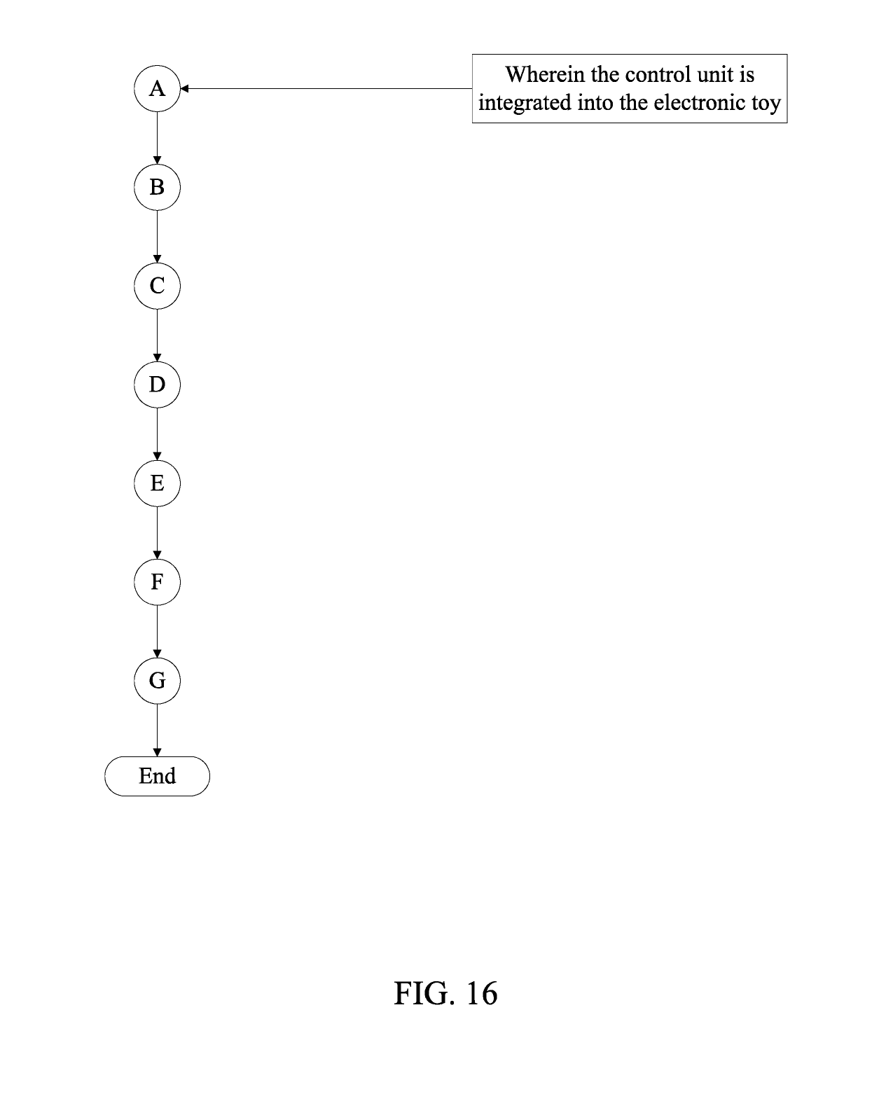

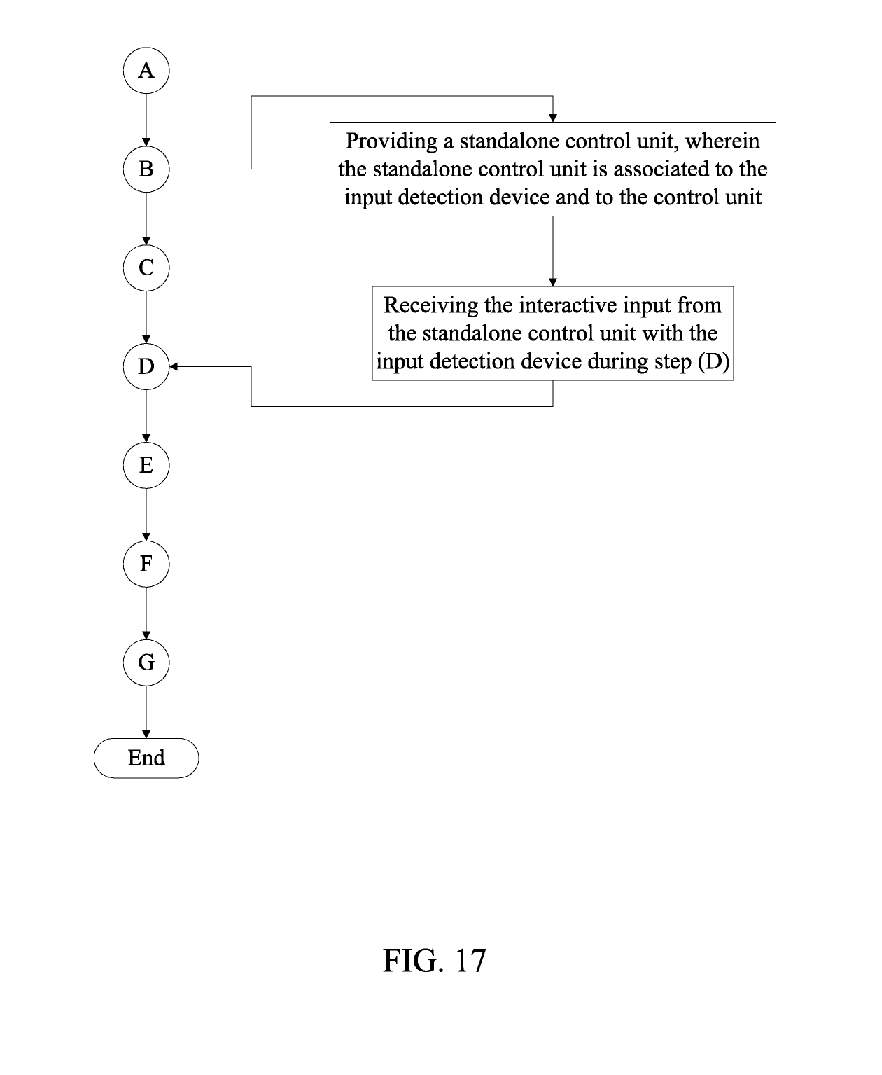

With reference to FIG. 16, the control unit may be integrated into the electronic toy to create an all-in-one toy. Alternatively, with reference to FIG. 17, a standalone control unit is provided. The standalone control unit is associated to the input detection device and to the control unit, enabling the standalone control unit to wirelessly communicate with both the input detection device and the control unit. The interactive input is received from the standalone control unit with the input detection device during step (D), enabling the electronic toy to receive commands and other inputs from the standalone control unit. The standalone control unit may be used to create a smaller or more aesthetically pleasing electronic toy. Both the integrated control unit and the standalone control unit may be used in conjunction with the computing device. Alternatively, both the integrated control unit and the standalone control unit may be used without the computing device. The standalone control unit may include a camera, an optical sensor, a motion sensor, or a similar device for detecting the movement of pets in the vicinity of the electronic toy and/or in the vicinity of the standalone control unit.

In various alternative embodiments of the present invention, the electronic toy is able to wirelessly communicate with one or more additional electronic toys in addition to communicating with the control unit. Additionally, electronic toy, the control unit, and the standalone control unit, may also access the Internet and perform various functions such as posting content to social media.

Although the present invention has been explained in relation to its preferred embodiment, it is understood that many other possible modifications and variations can be made without departing from the spirit and scope of the present invention as hereinafter claimed.

What is claimed is:

1. A method for providing an interactive toy response to a received input, the method comprises the steps of:
(A) providing an electronic toy, wherein the electronic toy comprises a toy body, at least one input detection device, and at least one interactive output device;
(B) providing a control unit, wherein the control unit is communicably coupled to the input detection device and to the interactive output device;
(C) continuously monitoring surrounding areas of the electronic toy with the input detection device;
(D) receiving an interactive input with the input detection device;
(E) sending the interactive input from the input detection device to the control unit;
(F) processing the interactive input with the control unit in order to determine an interactive output; and
(G) executing the interactive output with the interactive output device.

2. The method for providing an interactive toy response to a received input as claimed in claim 1, the method comprises the steps of:
providing a computing device, wherein the computing device is associated to the input detection device and to the control unit; and
receiving the interactive input from the computing device with the input detection device during step (D).

3. The method for providing an interactive toy response to a received input as claimed in claim 1, the method comprises the steps of:
providing a vibration motor and an audio-output device as the interactive output device; and
simultaneously activating the vibration motor and the audio-output device as the interactive output during step (G).

4. The method for providing an interactive toy response to a received input as claimed in claim 2, the method comprises the steps of:
transmitting a notification to the computing device with the control unit after step (G).

5. The method for providing an interactive toy response to a received input as claimed in claim 2, the method comprises the steps of:
providing a location module as the interactive output device; and
transmitting a toy location to the computing device as the interactive output with the interactive output device during step (G).

6. The method for providing an interactive toy response to a received input as claimed in claim 1, the method comprises the steps of:
executing multiple iterations of steps (D) through (G) in order to provide a continuous interactive toy response.

7. The method for providing an interactive toy response to a received input as claimed in claim 1, wherein the input detection device is a transceiver.

8. The method for providing an interactive toy response to a received input as claimed in claim 1, the method comprises the steps of:
providing a pressure sensor as the input detection device; and
receiving a haptic pressure input as the interactive input with the pressure sensor during step (D).

9. The method for providing an interactive toy response to a received input as claimed in claim 8, wherein the pressure sensor is separable from the toy body.

10. The method for providing an interactive toy response to a received input as claimed in claim 1, the method comprises the steps of:
providing a motion sensor as the input detection device; and
receiving a proximity movement as the interactive input with the motion sensor during step (D).

11. The method for providing an interactive toy response to a received input as claimed in claim 1, the method comprises the steps of:
providing a vibration motor as the interactive output device; and
actuating the vibration motor as the interactive output during step (G).

12. The method for providing an interactive toy response to a received input as claimed in claim 1, the method comprises the steps of:
providing at least one lighting device as the interactive output device; and
illuminating the lighting device as the interactive output during step (G).

13. The method for providing an interactive toy response to a received input as claimed in claim 1, the method comprises the steps of:
providing a propulsion device for the electronic toy; and
activating the propulsion device in order to move the electronic toy as the interactive output during step (G).

14. The method for providing an interactive toy response to a received input as claimed in claim 1, the method comprises the steps of:
providing an audio-output device as the interactive output device; and
playing a recorded audio file with the audio-output device as the interactive output during step (G).

15. The method for providing an interactive toy response to a received input as claimed in claim 14, the method comprises the steps of:
providing a data storage device, wherein the data storage device contains at least one recorded audio file, and wherein the data storage device is electronically connected to the audio-output device and to the control unit; and
retrieving the recorded audio file from the data storage device with the control unit during step (G).

16. The method for providing an interactive toy response to a received input as claimed in claim 1, wherein the control unit is integrated into the electronic toy.

17. The method for providing an interactive toy response to a received input as claimed in claim 1, the method comprises the steps of:
providing a standalone control unit, wherein the standalone control unit is associated to the input detection device and to the control unit; and
receiving the interactive input from the standalone control unit with the input detection device during step (D).
